(19) United States
(12) Patent Application Publication
(10) Pub. No.: US 2026/0001759 A1
(43) Pub. Date: Jan. 1, 2026

(54) DEVICE FOR IN-SITU HYDROGEN ABSORPTION AND HYDROLYSIS HYDROGEN PRODUCTION BASED ON MAGNESIUM-BASED SOLID HYDROGEN STORAGE ALLOY AND USE THEREOF

(71) Applicant: SHANGHAI JIAO TONG UNIVERSITY, Shanghai (CN)

(72) Inventors: Jianxin ZOU, Shanghai (CN); Li REN, Shanghai (CN); Xi LIN, Shanghai (CN)

(21) Appl. No.: 19/106,880

(22) PCT Filed: Jul. 10, 2024
(86) PCT No.: PCT/CN2024/104773

§ 371 Date: Feb. 26, 2025

(30) Foreign Application Priority Data
Jul. 10, 2023 (CN) 202310841087.4

(51) Int. Cl. C01B 3/00; B01J 20/02; B01J 20/30; C22C 23/00

(52) U.S. Cl. CPC C01B 3/0057; B01J 20/0248; B01J 20/3021; B01J 20/3078; C01B 3/0052; C22C 23/00; C22C 2202/04

(57) ABSTRACT

A device for in-situ hydrogen absorption and hydrolysis hydrogen production based on magnesium-based solid hydrogen storage alloys and use thereof are provided. The device can directly inject hydrogen into a stainless steel tank to allow the magnesium alloy absorbing hydrogen to generate the hydrogenated magnesium alloy. When hydrogen is needed later, water is introduced to hydrolyze the hydrogenated magnesium alloy to produce the hydrogen. In this process, the magnesium alloy does not need to be taken out and exposed to the air after absorbing hydrogen, nor does it need further treatment, such that the hydrogen absorption and hydrolysis hydrogen production of the magnesium alloy can be completed in steps in the same device, which greatly saves manufacturing time and cost of the hydrolysis hydrogen production tank.

### CROSS REFERENCE TO RELATED APPLICATION

The application is a national stage application of International Patent Application No. PCT/CN2024/104773, filed on Jul. 10, 2024, which claims priority of Chinese Patent Application No. 202310841087.4 filed on Jul. 10, 2023, both of which are incorporated by reference in their entirety.

### TECHNICAL FIELD

The present disclosure belongs to the technical field of hydrogen preparation and storage devices, and in particular relates to a device for in-situ hydrogen absorption and hydrolysis hydrogen production based on magnesium-based solid hydrogen storage alloys and use thereof.

### BACKGROUND

Energy is the foundation for the survival and development of human society. Fossil fuels such as coal, oil, and natural gas not only have limited reserves, but also cause serious environmental pollution and energy shortages due to excessive consumption. The primary strategy to solve this problem is to develop a clean and renewable green energy resource. Hydrogen energy is an emerging energy resource that has attracted much attention in the 21st century. As one of the basic components of water, hydrogen has many advantages over traditional fossil energy, including high energy density, abundant resources, environmental-friendly products, and excellent safety. The large-scale use of hydrogen energy faces many challenges, such as the production, storage, and transportation of hydrogen.

Solid-state hydrogen storage is safe and efficient and has a high mass hydrogen storage density and a volume hydrogen storage density. Magnesium is one of the most abundant light alloys on earth, while China has large abundant reserves. Magnesium hydride generated by the hydrogenation of metallic magnesium shows a high mass hydrogen storage density (7.6 wt % H₂) and a high volume hydrogen storage density (110 kg H₂·m⁻³). Magnesium hydride can release hydrogen through thermal decomposition and hydrolysis. Thermal decomposition to release hydrogen is an endothermic reaction which can only take place at high temperatures (not less than 300° C.); while hydrolysis is an exothermic reaction which can take place at room temperature, and has a hydrogen release amount up to 15.2 wt %, which is twice that of the thermal decomposition. As a result, the hydrolysis of magnesium hydride for hydrogen production has attracted widespread research interest.

However, the hydrogen absorption and hydrolysis of magnesium alloy in the previous magnesium hydride hydrolysis device are completed separately, greatly reducing hydrolysis efficiency of the material. Moreover, as the hydrolysis proceeds, a hydrolysis product Mg(OH)₂ gradually wraps around the surface of MgH₂ particles, thereby blocking the contact between MgH₂ and water, and then inhibiting the hydrolysis. Therefore, there is still a lot of research space in improving the hydrogen storage and hydrolysis efficiency of magnesium-based solid hydrogen storage materials.

### SUMMARY

In view of the above-mentioned defects in the prior art, the inventors have designed a hydrolysis hydrogen production tank, which can realize the in-situ hydrogen absorption and hydrolysis hydrogen production of the magnesium alloy simultaneously, thus greatly improving the efficiency of hydrolysis hydrogen production of the magnesium alloy, and then proposing the present disclosure.

Therefore, in one aspect, the present disclosure provides a device for in-situ hydrogen absorption and hydrolysis hydrogen production based on magnesium-based solid hydrogen storage alloys, including a stainless steel tank 1. An inner side of the stainless steel tank 1 is provided with a thermal insulation layer 2, a top of the stainless steel tank 1 is provided with a water inlet pipe 8 and a hydrogen pipe 9, the water inlet pipe 8 is provided with a water flow valve 7 and is connected to a porous air-guide duct 3 extending into the stainless steel tank 1, the hydrogen pipe 9 is provided with a hydrogen valve 6, and the porous air-guide duct 3 is externally wound with an electric heating wire 5.

Furthermore, the porous air-guide duct 3 is internally filled with a porous material to prevent powders from entering the porous air-guide duct.

Furthermore, the water inlet pipe 8 is provided with a water pump for controlling a flow rate of water and thus for controlling a flow rate of hydrogen.

Furthermore, the stainless steel tank 1 is loaded with magnesium alloy particles 4.

Furthermore, each of the magnesium alloy particles 4 is a magnesium-based hydrogen storage alloy selected from a group consisting of an Mg-1Al-7Ni-1Ce-0.5Zr hydrogen storage alloy, an Mg-0.5Ti-7Ni-2.5Co-0.5Ce hydrogen storage alloy, an Mg-0.5Ti-7Ni-2Co-0.5Ce-0.5La hydrogen storage alloy, and an Mg-0.5Ti-7Ni-1.5Co-0.5Ce-0.5La-0.5Nd hydrogen storage alloy.

Furthermore, the magnesium-based hydrogen storage alloy is prepared by a preparation method including: heating to melt Mg under a protective atmosphere, and then adding one or more of an Mg—Ti intermediate alloy, an Mg—Al intermediate alloy, an Mg—Ni intermediate alloy, an Mg—Co intermediate alloy, an Mg—Zr intermediate alloy, an Mg—Na intermediate alloy, an Mg—Ce intermediate alloy, an Mg—La intermediate alloy, an Mg—Nd intermediate alloy, and an Mg—Y intermediate alloy, wherein intermediate alloys have a total content of 0.01% to 30% by weight; fully mixing raw materials by stirring, cooling the raw materials down to a room temperature at a rate of 50 K/min to prepare the magnesium-based hydrogen storage alloy; and crushing and sieving the magnesium-based hydrogen storage alloy in air, and then pressing the magnesium-based hydrogen storage alloy to obtain the magnesium alloy particles 4.

Intermediate alloys are special alloys that use one metal as the matrix and incorporate one or more elemental substances into the matrix, to solve problems such as easy burning loss, difficulty in melting due to high melting points, and easy segregation caused by high densities of the one metal, or to improve the properties of alloys. Intermediate alloys are also a type of additive functional material. The Mg—X intermediate alloy used in this disclosure is an alloy that uses metallic magnesium as the matrix and adds metallic X into the matrix, which can be purchased commercially. The metallic X includes one or more of Ti, Al, Ni, Co, Zr, Na, Ce, La, Nd and Y.

In another aspect, the present disclosure provides a method for in-situ hydrogen absorption and hydrolysis hydrogen production based on magnesium-based solid hydrogen storage alloys, including:

S0, adding magnesium alloy particles 4 into a stainless steel tank 1;

S1, closing a hydrogen valve 6 and a water flow valve 7, energizing an electric heating wire to heat a tank body of the stainless steel tank to a set temperature of 100° C.-400° C., opening the hydrogen valve 6 to introduce hydrogen with a pressure of 3 MPa, closing the hydrogen valve 6 and keeping at the set temperature for 2 h, and then cooling the tank body of the stainless steel tank naturally to a room temperature, such that the magnesium alloy particles absorb hydrogen to generate a composite hydrogen storage material mainly containing MgH₂;

S2, energizing the electric heating wire to heat the tank body to 80° C.-100° C., opening the water flow valve 7, introducing water into a porous air-guide duct 3 through a water pump, opening the hydrogen valve 6, and then collecting the hydrogen generated by hydrolysis; and

S3, closing the water flow valve 7 and the hydrogen valve 6 after the hydrolysis is completed.

Furthermore, the tank body in S1 is heated to 200° C.-300° C., such as 200° C., 250° C., or 300° C.

Furthermore, each of the magnesium alloy particles 4 in S0 is a magnesium-based hydrogen storage alloy selected from a group consisting of an Mg-1Al-7Ni-1Ce-0.5Zr hydrogen storage alloy, an Mg-0.5Ti-7Ni-2.5Co-0.5Ce hydrogen storage alloy, an Mg-0.5Ti-7Ni-2Co-0.5Ce-0.5La hydrogen storage alloy, and an Mg-0.5Ti-7Ni-1.5Co-0.5Ce-0.5La-0.5Nd hydrogen storage alloy.

### Technical Effects

In the present disclosure, the device for in-situ hydrogen absorption and hydrolysis hydrogen production based on magnesium-based solid hydrogen storage alloys can realize the simultaneous in-situ hydrogen absorption and hydrolysis hydrogen production of magnesium alloy. The electric heating wire 5 is energized, such that a temperature of the electric heating wire 5 reaches the hydrogen absorption temperature of the magnesium alloy particles 4, and then the hydrogen valve 6 is opened to introduce hydrogen through the porous air-guide duct 3, such that the magnesium alloy particles 4 sufficiently absorb hydrogen. Then the hydrogen-absorbed magnesium alloy does not need to be taken out from the tank body. When hydrogen is needed, water could be directly injected into the tank body through the water flow valve 7 to hydrolyze the magnesium hydride to produce hydrogen, which could greatly improve a hydrolysis hydrogen production efficiency of the magnesium alloy particles 4. The hydrogen generated by electrolysis of water is directly injected into the stainless steel tank 1 as a hydrogen source for the magnesium alloy to absorb hydrogen. When hydrogen is needed later, water is directly introduced to hydrolyze the hydrogenated magnesium alloy to produce hydrogen. In this process, no additional magnesium hydride alloy is required, and the magnesium alloy particles 4 do not need to be taken out and exposed to the air after absorbing hydrogen. The hydrogen absorption and hydrolysis hydrogen production of the magnesium alloy particles 4 could be completed in a same device, which greatly saves manpower and material resources.

In the present disclosure, one or more alloying elements selected from Ni, Al, Ti, Co, Zr, La, Ce, Nd, Na and Y are added. During the hydrogenation process of magnesium alloy particles 4, the combined catalytic effect of hydrides such as LaH₃, CeH₃, NdH₃, NaH and ZrH₂ is formed simultaneously, which significantly promotes the hydrolysis of MgH₂. Meanwhile, the hydrolysis of LaH₃ generates conductive ions, creating a synergistic effect for promotion. In addition, the low hydrogen overpotential in Ni and Co makes them excellent cathode materials. The dispersed Ni/Co and metallic Mg form tiny primary cells therebetween, which also promotes the hydrolysis of MgH₂. The addition of alloying elements improves the hydrolysis kinetic property of magnesium hydride, and other metal hydrides formed during the hydrogenation process of magnesium alloys effectively prevent the formation of the Mg(OH)₂ wrapping layer during the hydrolysis process.

In the present disclosure, the flow rate of hydrogen is controlled by using a water pump to control the flow rate of water. Porous materials including sintered plates or ceramic membranes are filled in the porous air-guide duct 3 to prevent powder from entering the air-guide duct and further prevent the blockage of the pipeline, so that the hydrogen production rate of MgH₂ can be stably controlled.

In the present disclosure, the air stability of magnesium alloys is improved by adding alloy elements. The hydrogen production tank can be filled with hydrogen and stored in a sealed manner. By controlling the alloy composition, an antioxidant protective layer is formed on the surface of magnesium-based hydrogen storage alloys. In the present disclosure, magnesium alloy particles 4 with air stability for hydrolysis hydrogen production are synthesized, and magnesium alloy particles 4 possess excellent hydrolysis kinetic properties, which are suitable for hydrogen supply equipment in humid environments.

### BRIEF DESCRIPTION OF THE DRAWINGS

FIG. 1 shows a schematic structural diagram of the device for in-situ hydrogen absorption and hydrolysis hydrogen production based on magnesium-based solid hydrogen storage alloys in Embodiment 1 of the present disclosure;

FIG. 2 shows a hydrogen absorption curve of a Mg-1Al-7Ni-1Ce-0.5Zr hydrogen storage alloy used in Embodiment 1 of the present disclosure; and

FIG. 3 shows a hydrolysis hydrogen production curve of the Mg-1Al-7Ni-1Ce-0.5Zr hydrogen storage alloy in Embodiment 1 of the present disclosure.

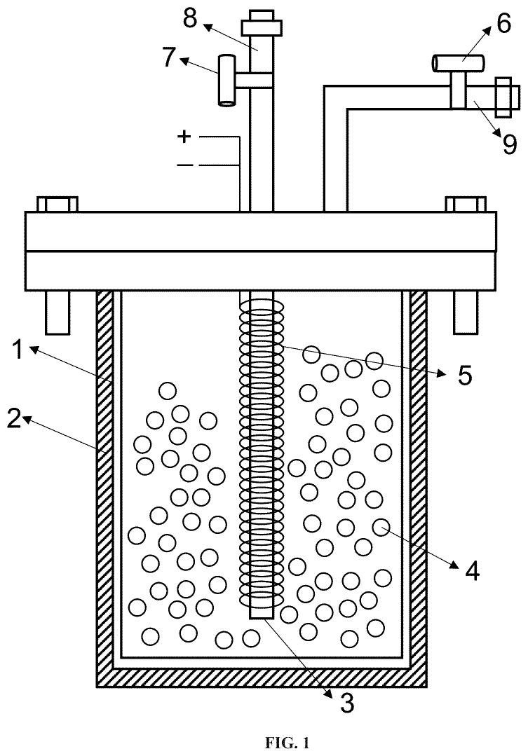

Reference numerals in FIG. 1: 1 stainless steel tank; 2 thermal insulation layer; 3 porous air-guide duct; 4 magnesium alloy particle; 5 electric heating wire; 6 hydrogen valve; 7 water flow valve; 8 water inlet pipe; and 9 hydrogen pipe.

### DETAILED DESCRIPTION OF THE EMBODIMENTS

A number of preferred embodiments of the present disclosure will be introduced below with reference to the accompanying drawings, such that the technical solutions can be clearly and easily understood. This application can be embodied through embodiments of different forms, and the protection scope of this application is not limited to the embodiments mentioned herein.

### Embodiment 1

A device for in-situ hydrogen absorption and hydrolysis hydrogen production based on magnesium-based solid hydrogen storage alloys shown in FIG. 1 includes a stainless steel tank 1. An outer side of the stainless steel tank 1 is provided with a thermal insulation layer 2, a top of the stainless steel tank 1 is provided with a water inlet pipe 8 and a hydrogen pipe 9, the water inlet pipe 8 is provided with a water flow valve 7 and is connected to a porous air-guide duct 3 extending into the stainless steel tank 1, the hydrogen pipe 9 is provided with a hydrogen valve 6, and the porous air-guide duct 3 is externally wound with an electric heating wire 5. The water inlet pipe 8 is provided with a water pump for controlling a flow rate of water and thus for controlling a flow rate of hydrogen.

An in-situ hydrogen absorption and hydrolysis hydrogen production process of the hydrolysis hydrogen production device includes the following steps:

S0, magnesium alloy particles 4 of Mg-1Al-7Ni-1Ce-0.5Zr hydrogen storage alloy prepared by crushing are added into the stainless steel tank 1;

S1, the hydrogen valve 6 and the water flow valve 7 are closed, the electric heating wire is energized to heat a tank body of the stainless steel tank to a set temperature of 200° C., the hydrogen valve 6 is opened to introduce hydrogen with a pressure of 3 MPa, the hydrogen valve 6 is closed and the set temperature and the pressure are kept for 2 h, and then the tank body of the stainless steel tank is cooled naturally to a room temperature,

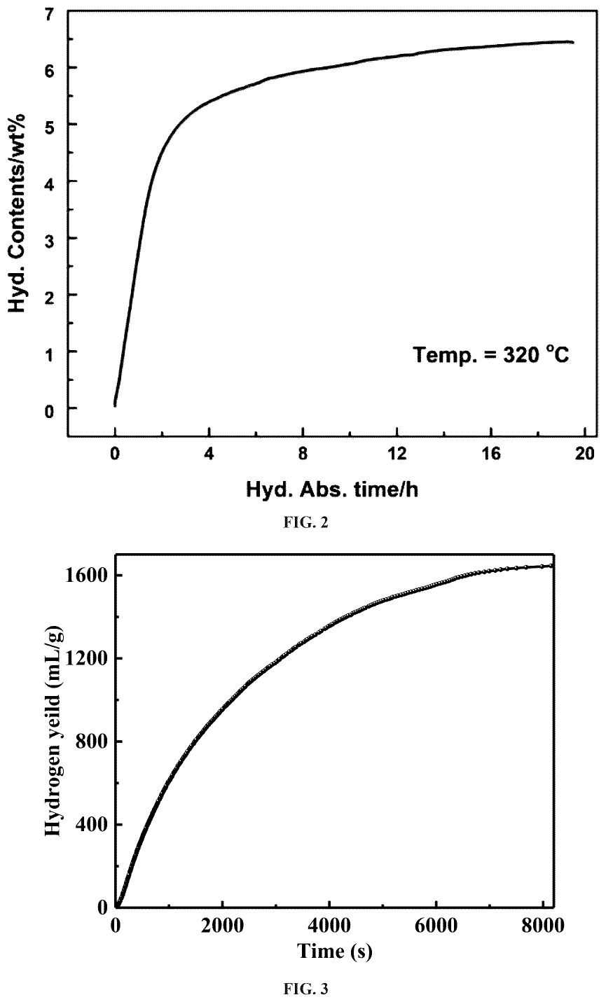

in the process above, the magnesium alloy particles absorb hydrogen to generate a composite hydrogen storage material mainly containing MgH₂ and a hydrogen absorption curve of the Mg-1Al-7Ni-1Ce-0.5Zr hydrogen storage alloy in the process is shown in FIG. 2;

S2, the electric heating wire is energized to heat the tank body to 80° C.-100° C., the water flow valve 7 is opened, water is introduced into the porous air-guide duct 3 through the water pump, the hydrogen valve 6 is opened, and then the hydrogen generated by hydrolysis is collected; a hydrolysis hydrogen production curve of the Mg-1Al-7Ni-1Ce-0.5Zr hydrogen storage alloy is shown in FIGS. 3; and

S3, the water flow valve 7 and the hydrogen valve 6 are closed after the hydrolysis is completed.

### Embodiment 2

The heating temperature of step S1 in Embodiment 1 is adjusted to 250° C., while other conditions or parameters is consistent with those in Embodiment 1. Compared with Embodiment 1, the hydrogen absorption time is shorter and the hydrogen production rate is higher.

If the hydrogen absorption in step S1 is performed at a relatively low temperature, a part of magnesium alloy might not sufficiently absorb hydrogen, which could affect the subsequent hydrolysis hydrogen production. Therefore, the heating temperature of the hydrogen absorption in step S1 is controlled at not less than 100° C., and the speed of hydrogen production in step S2 is accelerated as the heating temperature increases.

### Embodiment 3

The heating temperature of step S1 in Embodiment 1 is adjusted to 300° C., while other conditions or parameters is consistent with those in Embodiment 1. Compared with Embodiment 1, the amount of hydrogen absorption is larger and the total amount of hydrogen production is larger.

This indicates that appropriately increasing the heating temperature of step S1 is beneficial to the hydrogen absorption time, the amount of hydrogen absorption amount, and the amount of hydrogen production. However, an excessively high heating temperature causes the magnesium alloy to be pulverized, agglomerated, and grown up, thereby affecting its hydrogen absorption and subsequent hydrolysis hydrogen production performance.

### Preparation Embodiment 1

A preparation process of the magnesium alloy particles (Mg-1Al-7Ni-1Ce-0.5Zr hydrogen storage alloy) in Embodiment 1 is as follows: metallic magnesium and metallic magnesium-based intermediate alloy are used as raw materials, the metallic magnesium-based intermediate alloys include Mg—Al intermediate alloy, Mg—Ni intermediate alloy, Mg—Ce intermediate alloy, and Mg—Zr intermediate alloy, and the amount of addition of various metals are controlled. The magnesium-based hydrogen storage alloy is obtained by high-temperature melting. Firstly, Mg is melted at elevated temperature under protective atmosphere, after which Mg—Al intermediate alloy, Mg—Ni intermediate alloy, Mg—Ce intermediate alloy, and Mg—La intermediate alloy are added sequentially and proportionally. After all raw materials are fully stirred and mixed homogeneously, they are cooled down to a room temperature at a rate of 50 K/min, to prepare the Mg-1Al-7Ni-1Ce-0.5Zr hydrogen storage alloy, which is crushed and sieved in air and then pressed to obtain magnesium alloy particles.

### Preparation Embodiment 2

A preparation process of the magnesium alloy particles (Mg-0.5Ti-7Ni-2.5Co-0.5Ce hydrogen storage alloy) is as follows: metallic magnesium and metallic magnesium-based intermediate alloy are used as raw materials, and the amount of addition of various metals are controlled. The magnesium-based hydrogen storage alloy is obtained by high-temperature melting. Firstly, Mg is melted at elevated temperature under protective atmosphere, after which Mg—Ti intermediate alloy, Mg—Ni intermediate alloy, Mg—Co intermediate alloy, and Mg—Ce intermediate alloy are added sequentially and proportionally. After all raw materials are fully stirred and mixed homogeneously, they are cooled down to a room temperature at a rate of 50 K/min, to prepare the Mg-0.5Ti-7Ni-2.5Co-0.5Ce hydrogen storage alloy, which is crushed and sieved in air and then pressed to obtain magnesium alloy particles.

### Preparation Embodiment 3

A preparation process of the magnesium alloy particles (Mg-0.5Ti-7Ni-2Co-0.5Ce-0.5La hydrogen storage alloy) is as follows: metallic magnesium and metallic magnesium-based intermediate alloy are used as raw materials, and the amount of addition of various metals are controlled. The magnesium-based hydrogen storage alloy is obtained by high-temperature melting. Firstly, Mg is melted at elevated temperature under protective atmosphere, after which Mg—Ti intermediate alloy, Mg—Ni intermediate alloy, Mg—Co intermediate alloy, Mg—Ce intermediate alloy and Mg—La intermediate alloy are added sequentially and proportionally. After all raw materials are fully stirred and mixed homogeneously, they are cooled down to a room temperature at a rate of 50 K/min, to prepare the Mg-0.5Ti-7Ni-2Co-0.5Ce-0.5La hydrogen storage alloy, which is crushed and sieved in air and then pressed to obtain magnesium alloy particles.

### Preparation Embodiment 4

A preparation process of the magnesium alloy particles (Mg-0.5Ti-7Ni-1.5Co-0.5Ce-0.5La-0.5Nd hydrogen storage alloy) is as follows: metallic magnesium and metallic magnesium-based intermediate alloy are used as raw materials, and the amount of addition of various metals are controlled. The magnesium-based hydrogen storage alloy is obtained by high-temperature melting. Firstly, Mg is melted at elevated temperature under protective atmosphere, after which Mg—Ti intermediate alloy, Mg—Ni intermediate alloy, Mg—Co intermediate alloy, Mg—Na intermediate alloy, Mg—Ce intermediate alloy, Mg—La intermediate alloy and Mg—Nd intermediate alloy are added sequentially and proportionally. After all raw materials are fully stirred and mixed homogeneously, they are cooled down to a room temperature at a rate of 50 K/min, to prepare the Mg-0.5Ti-7Ni-1.5Co-0.5Ce-0.5La-0.5Nd hydrogen storage alloy, which is crushed and sieved in air and then pressed to obtain magnesium alloy particles.

In addition, in the preparation processes of the hydrogen storage alloys mentioned above, the Mg—Ce intermediate alloy is selectively adjusted to the Mg—La intermediate alloy, or the Mg—Ce intermediate alloy is adjusted to the Mg—Nd intermediate alloy, or the Mg—La intermediate alloy is adjusted to the Mg—Nd intermediate alloy, or the Mg—Ce intermediate alloy is adjusted to the Mg—Nd intermediate alloy. In the device for in-situ hydrogen absorption and hydrolysis hydrogen production based on magnesium-based solid hydrogen storage alloys, all magnesium alloy particles 4 prepared above could realize the simultaneous in-situ hydrogen absorption and hydrolysis hydrogen production of magnesium alloy. The electric heating wire 5 is energized, such that a temperature of the electric heating wire 5 reaches the hydrogen absorption temperature of the magnesium alloy particles 4, and then the hydrogen valve 6 is opened to introduce hydrogen through the porous air-guide duct 3, such that the magnesium alloy particles 4 sufficiently absorb hydrogen. Then the hydrogen-absorbed magnesium alloy does not need to be taken out from the tank body. When hydrogen is needed, water could be directly injected into the tank body through the water flow valve 7 to hydrolyze the magnesium hydride to produce hydrogen, which could greatly improve a hydrolysis hydrogen production efficiency of the magnesium alloy particles 4. The hydrogen generated by electrolysis of water is directly injected into the stainless steel tank 1 as a hydrogen source for the magnesium alloy to absorb hydrogen. When hydrogen is needed later, water is directly introduced to hydrolyze the hydrogenated magnesium alloy to produce hydrogen. In this process, no additional magnesium hydride alloy is required, and the magnesium alloy particles 4 do not need to be taken out and exposed to the air after absorbing hydrogen. The hydrogen absorption and hydrolysis hydrogen production of the magnesium alloy particles 4 could be completed in a same device, which greatly saves manpower and material resources.

Preferred specific examples of this application are described in detail above. It should be understood that, a person of ordinary skill in the art can make various modifications and variations according to the concept of this application without creative efforts. Therefore, all technical solutions that can be obtained by a person skilled in the art based on the prior art through logical analysis, deduction, or limited experiments according to the concept of this application should fall within the protection scope defined by the claims.

What is claimed is:

1. A device for in-situ hydrogen absorption and hydrolysis hydrogen production based on magnesium-based solid hydrogen storage alloys, comprising a stainless steel tank (1), wherein an inner side of the stainless steel tank (1) is provided with a thermal insulation layer (2), a top of the stainless steel tank (1) is provided with a water inlet pipe (8) and a hydrogen pipe (9), the water inlet pipe (8) is provided with a water flow valve (7) and is connected to a porous air-guide duct (3) extending into the stainless steel tank (1), the hydrogen pipe (9) is provided with a hydrogen valve (6), and the porous air-guide duct (3) is externally wound with an electric heating wire (5).

2. The device according to claim 1, wherein the porous air-guide duct (3) is internally filled with a porous material.

3. The device according to claim 2, wherein the porous material comprises a sintered plate or a ceramic.

4. The device according to claim 1, wherein the water inlet pipe (8) is provided with a water pump for controlling a flow rate of water and thus for controlling a flow rate of hydrogen.

5. The device according to claim 1, wherein the stainless steel tank (1) is loaded with magnesium alloy particles (4).

6. The device according to claim 5, wherein each of the magnesium alloy particles (4) is a magnesium-based hydrogen storage alloy selected from a group consisting of an Mg-1Al-7Ni-1Ce-0.5Zr hydrogen storage alloy, an Mg-0.5Ti-7Ni-2.5Co-0.5Ce hydrogen storage alloy, an Mg-0.5Ti-7Ni-2Co-0.5Ce-0.5La hydrogen storage alloy, and an Mg-0.5Ti-7Ni-1.5Co-0.5Ce-0.5La-0.5Nd hydrogen storage alloy.

7. The device according to claim 6, wherein the magnesium-based hydrogen storage alloy is prepared by a preparation method comprising: heating to melt Mg under a protective atmosphere, and then adding one or more of an Mg—Ti intermediate alloy, an Mg—Al intermediate alloy, an Mg—Ni intermediate alloy, an Mg—Co intermediate alloy, an Mg—Zr intermediate alloy, an Mg—Na intermediate alloy, an Mg—Ce intermediate alloy, an Mg—La intermediate alloy, an Mg—Nd intermediate alloy, and an Mg—Y intermediate alloy, wherein intermediate alloys have a total content of 0.01% to 30% by weight; fully mixing raw materials by stirring, cooling the raw materials down to a room temperature at a rate of 50 K/min to prepare the magnesium-based hydrogen storage alloy; and crushing and sieving the magnesium-based hydrogen storage alloy in air, and then pressing the magnesium-based hydrogen storage alloy to obtain the magnesium alloy particles (4).

8. A method for in-situ hydrogen absorption and hydrolysis hydrogen production based on magnesium-based solid hydrogen storage alloys, comprising:
S0, adding magnesium alloy particles (4) into a stainless steel tank (1);
S1, closing a hydrogen valve (6) and a water flow valve (7), energizing an electric heating wire to heat a tank body of the stainless steel tank (1) to a set temperature of 100° C.-400° C., opening the hydrogen valve (6) to introduce hydrogen with a pressure of 3 MPa, closing the hydrogen valve (6) and keeping at the set temperature for 2 h-3 h, and then cooling the tank body of the stainless steel tank (1) naturally to a room temperature, such that the magnesium alloy particles absorb hydrogen to generate a composite hydrogen storage material mainly containing MgH₂;
S2, energizing the electric heating wire to heat the tank body to 80° C.-100° C., opening the water flow valve (7), introducing water into a porous air-guide duct (3) through a water pump, opening the hydrogen valve (6), and then collecting hydrogen generated by hydrolysis; and
S3, closing the water flow valve (7) and the hydrogen valve (6) after the hydrolysis is completed.

9. The method according to claim 8, wherein the tank body in S1 is heated to 200° C.-300° C.

10. The method according to claim 8, wherein each of the magnesium alloy particles (4) is a magnesium-based hydrogen storage alloy selected from a group consisting of an Mg-1Al-7Ni-1Ce-0.5Zr hydrogen storage alloy, an Mg-0.5Ti-7Ni-2.5Co-0.5Ce hydrogen storage alloy, an Mg-0.5Ti-7Ni-2Co-0.5Ce-0.5La hydrogen storage alloy, and an Mg-0.5Ti-7Ni-1.5Co-0.5Ce-0.5La-0.5Nd hydrogen storage alloy.
